(19) United States
(12) Patent Application Publication
(10) Pub. No.: US 2012/0031737 A1
(43) Pub. Date: Feb. 9, 2012

(54) DEVICE FOR CONVEYING OBJECTS IN PACKAGING MACHINES

(75) Inventors: GUENTER FELK, Ulm (DE); Fritz Fochler, Illerkirchberg (DE); Joachim Stahl, Neu-Ulm (DE)

(73) Assignee: UHLMANN PAC-SYSTEME GMBH & CO., KG, Laupheim (DE)

(21) Appl. No.: 13/185,936

(22) Filed: Jul. 19, 2011

(30) Foreign Application Priority Data
Aug. 5, 2010 (EP) 10172001.9

(51) Int. Cl. B65G 17/14

(52) U.S. Cl. 198/604

(57) ABSTRACT

The device for conveying objects in packaging machines has a first endless transport unit, which moves first driver elements; a second endless transport unit, which moves second driver elements; a motor-driven drive shaft, which drives the first endless transport unit; an auxiliary shaft, which drives the second endless transport unit; and a belt-type or chain-type connecting element for transmitting drive power from the drive shaft to the auxiliary shaft. The connecting element is guided between the drive shaft and the auxiliary shaft over a plurality of stationary auxiliary rollers and over at least two adjusting rollers, which can be shifted simultaneously in a direction perpendicular to their axes of rotation. The connecting element is guided in such a way that a shift of the adjusting rollers brings about a movement of the connecting element on the auxiliary shaft and thus a change in the angular position of the auxiliary shaft.

### RELATED APPLICATIONS

The present patent document claims the benefit of priority to European Patent Application No. EP 10172001.9, filed Aug. 5, 2010, and entitled “DEVICE FOR CONVEYING OBJECTS IN PACKAGING MACHINES,” the entire contents of each of which are incorporated herein by reference.

### FIELD AND BACKGROUND

The invention relates to a device for conveying objects in packaging machines.

These types of devices are used in particular in the pharmaceutical industry to transport folding boxes, into which stacks of blister packs are to be inserted. Such devices for conveying objects in packaging machines usually consist of two endless transport units, usually in the form of roller chains, which move the objects forward. The first transport unit, like the second unit, is equipped with driver elements in the form of upward-projecting fingers, for example, which serve to support the objects. Driver elements which function as pushing elements are assigned to the first transport unit, whereas the driver elements of the second transport unit function as counterholding elements. The distance between the pushing driver elements and the counterholding driver elements, which is defined by the relative position of the two transport devices, thus determines the size of the support surface available for the objects.

When the format is to be changed to accommodate packages of a different size, it is therefore necessary for the pushing driver elements to be shifted relative to the counterholding driver elements. This is accomplished by shifting the positions of the two transport units with respect to each other. The distances must be observed with millimeter accuracy.

In modern devices for conveying objects in packaging machines, the two endless transport units are driven by two shafts; the first shaft is connected to a drive motor and is also connected to the second shaft by way of a belt drive, for example. When the format is to be changed, manual operations are usually required.

It is known from DE 101 23 220 A1 that a self-locking adjusting device can be provided, which is connected to a first shaft and which can be actuated manually via an opening. To make the adjustment, an adapter is rotated relative to the first shaft, and this rotational movement is transmitted by a toothed belt and a toothed disk to the second shaft, the angular position of which with respect to the first shaft is thus changed. After the adjustment process, it is necessary to conduct reference and control runs.

In DE 10 2006 007 986 A1, it is proposed that the two shafts be connected by a clutch, which is not specified in detail, so that the drive, under normal operating conditions, moves the two transport units parallel to each other, whereas, under format adjustment conditions, it moves them relative to each other. No details of a concrete realization, however, are presented. Every automatic change or format requires in principle a large number of individual parts and a considerable amount of control engineering.

### BRIEF SUMMARY

It is an object of the present invention to provide a device for conveying objects in packaging machines, in which the changeover to a new format can be accomplished with modest mechanical effort, with considerable speed, and with precise adjustment.

According to an aspect of the invention, the device for conveying objects in packaging machines comprises:

a first endless transport unit, which moves first driver elements;

a second endless transport unit, which moves second driver elements;

a drive shaft, which is driven by a motor and which drives the first endless transport unit;

an auxiliary shaft, which drives the second endless transport unit; and

a belt-type or chain-type connecting element for transmitting the drive power from the drive shaft to the auxiliary shaft.

The connecting element between the drive shaft and the auxiliary shaft is guided over a plurality of stationary auxiliary rollers and over at least two adjusting rollers, which can be shifted simultaneously in the direction perpendicular to their axes of rotation. The connecting element is guided in such a way that a shift of the adjusting rollers brings about a movement of the connecting element on the auxiliary shaft and thus a change in the angular position of the auxiliary shaft.

With this design, the complicated process of changing formats can be accomplished easily and quickly, if necessary even while the device is operating, wherein highly precise adjustments are possible.

In a preferred embodiment, the adjusting rollers can be shifted in the same direction. As a result, the mechanism for format change occupies only a small amount of space.

It is also advantageous for the adjusting rollers to be of equal size and to be shiftable over the same distance. In this way, the simplest possible mechanical design is created, which makes the adjustment process especially easy.

Both the auxiliary rollers and the adjusting rollers can be arranged in axially symmetric fashion with respect to an axis of symmetry, as a result of which it becomes even easier to calculate the distance by which they must be shifted. Ideally, the axis of symmetry passes through the axes of rotation of the drive shaft and of the auxiliary shaft.

When the adjusting rollers are shifted, optimal transmission of the power to the auxiliary shaft can be achieved by ensuring that the section of the connecting element which is entering the adjusting roller is parallel to the section of the connecting element which is leaving the adjusting roller.

In a preferred embodiment, the connecting element is a toothed belt, toothed belt pulleys are mounted on the drive shaft and on the auxiliary shaft, and the adjusting rollers are toothed belt pulleys.

Alternatively, the connecting element can be a roller chain, sprockets are mounted on the drive shaft and on the auxiliary shaft, and the adjusting rollers are sprockets.

So that the adjusting mechanism can be guided reliably, the adjusting rollers can be shifted by means of a linear guide unit.

The linear guide unit can comprise a format adjusting plate, which is permanently connected to the adjusting rollers and which is guided in at least one straight guide rail.

The auxiliary shaft can be shifted precisely and thus rotated with millimeter accuracy by the use of an adjusting motor with an integrated absolute encoder to shift the adjusting rollers. Then there is also no need for any reference runs or control measurements when changing formats.

In one embodiment, the adjusting motor drives a spindle of the linear guide unit.

So that both transport units can be driven in the area where they reverse direction, the auxiliary shaft is preferably connected by means of a belt drive to an engagement unit rotatably supported on the drive shaft; this engagement unit engages with the second endless transport unit and thus drives it. As a result, the drive mechanisms for both transport units are supported on the drive shaft and are thus directly adjacent to each other.

In a preferred embodiment, the engagement unit can comprise a toothed belt pulley supported rotatably on the drive shaft, this pulley being connected to the belt drive and permanently connected to a sprocket, which is also mounted rotatably on the drive shaft. The sprocket in turn engages in the second endless transport unit and thus drives it.

### BRIEF DESCRIPTION OF THE DRAWINGS

Additional features and advantages of the present invention can be derived from the following description, which refers to the drawings:

FIG. 1 is a schematic perspective view of essential elements of a device for conveying objects in packaging machines according to the invention;

FIG. 2 is a schematic perspective view of the drive section of the device for conveying objects in packaging machines;

FIG. 3 shows a cross section through the drive section of the device for conveying objects in packaging machines;

FIG. 4 is a schematic perspective view of the drive section of the device for conveying objects in packaging machines with an adjusting motor for the adjusting rollers;

FIG. 5 is a schematic perspective view of the drive section of FIG. 4 with a linear guide unit for shifting the adjusting rollers;

FIG. 6 is a perspective top view of the partial area shown in FIG. 5;

FIG. 7 is a schematic perspective view of the rear of the drive section shown in FIG. 6; and

FIG. 8 is a perspective cross-sectional diagram of the drive section of FIG. 6.

### DETAILED DESCRIPTION OF SPECIFIC EMBODIMENTS

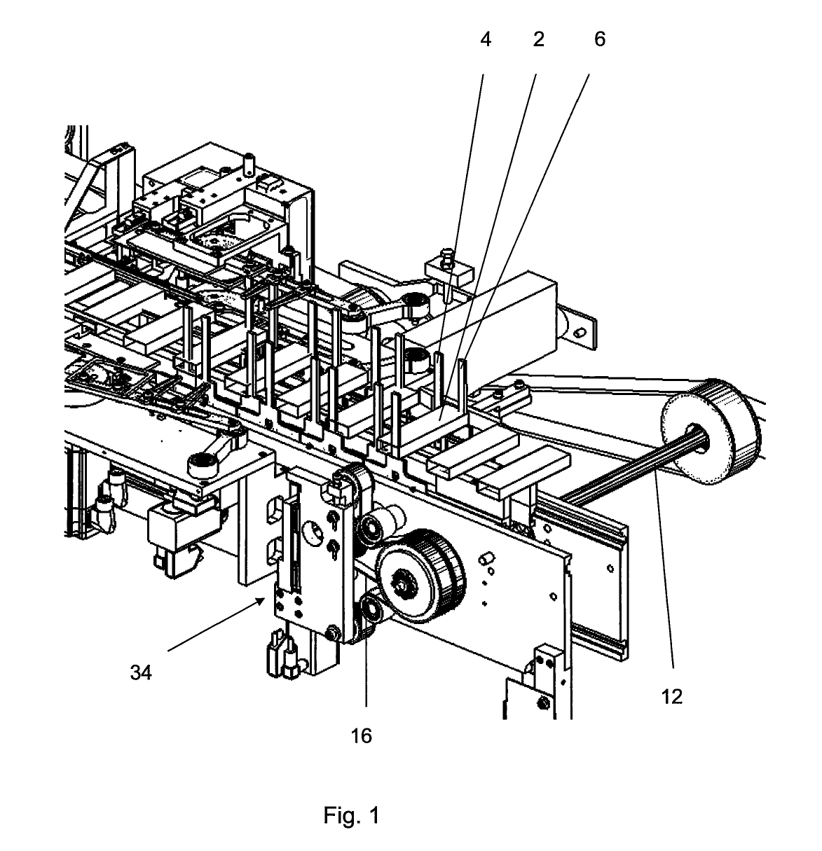

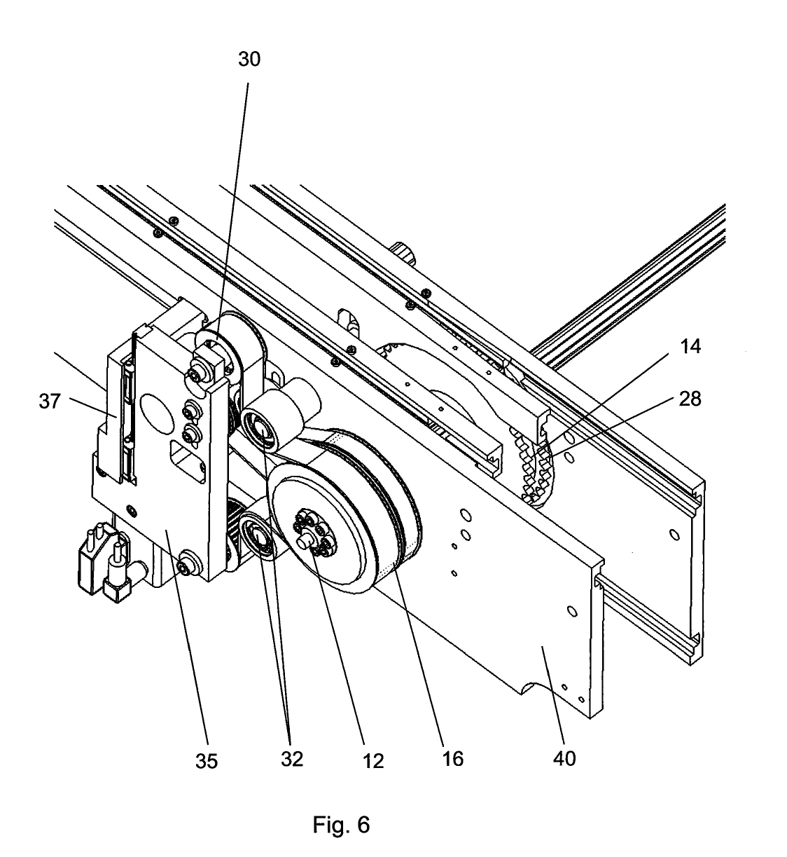

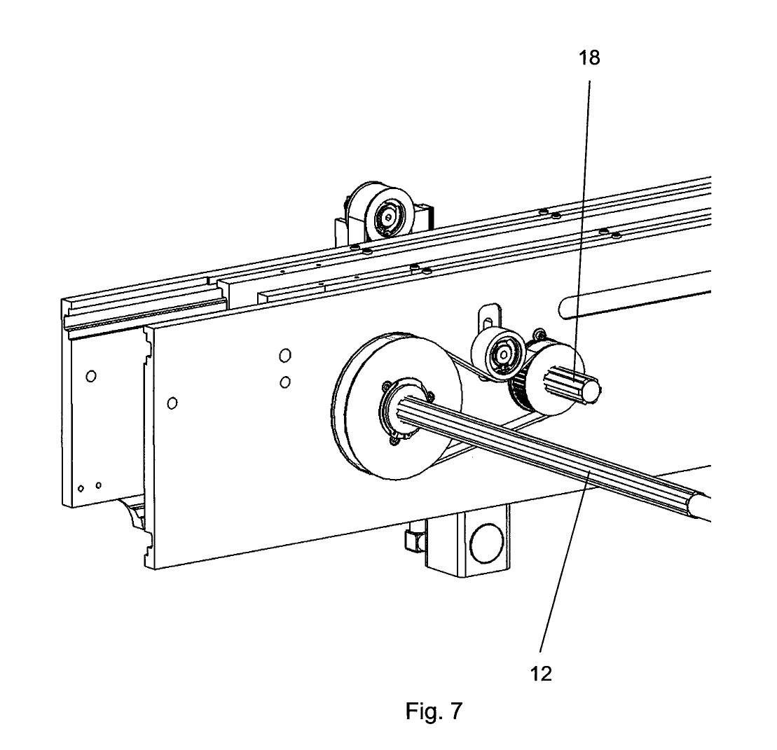

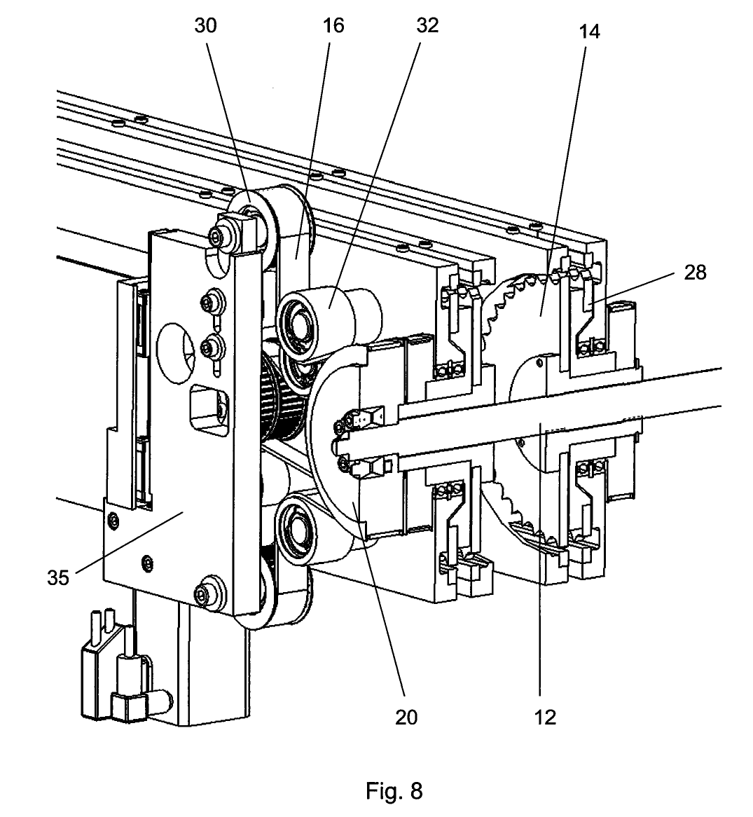

The invention is described in detail below with reference to the exemplary embodiment illustrated in FIGS. 1-8.

So that objects 2, especially folding boxes, can be transported during the packaging process, receiver cells adapted to the size of the objects 2 must be formed. Because the width of the receiver cells may have to be changed depending on the format of the objects 2 to be transported, it should be possible to adjust the size of the receiver cell slightly.

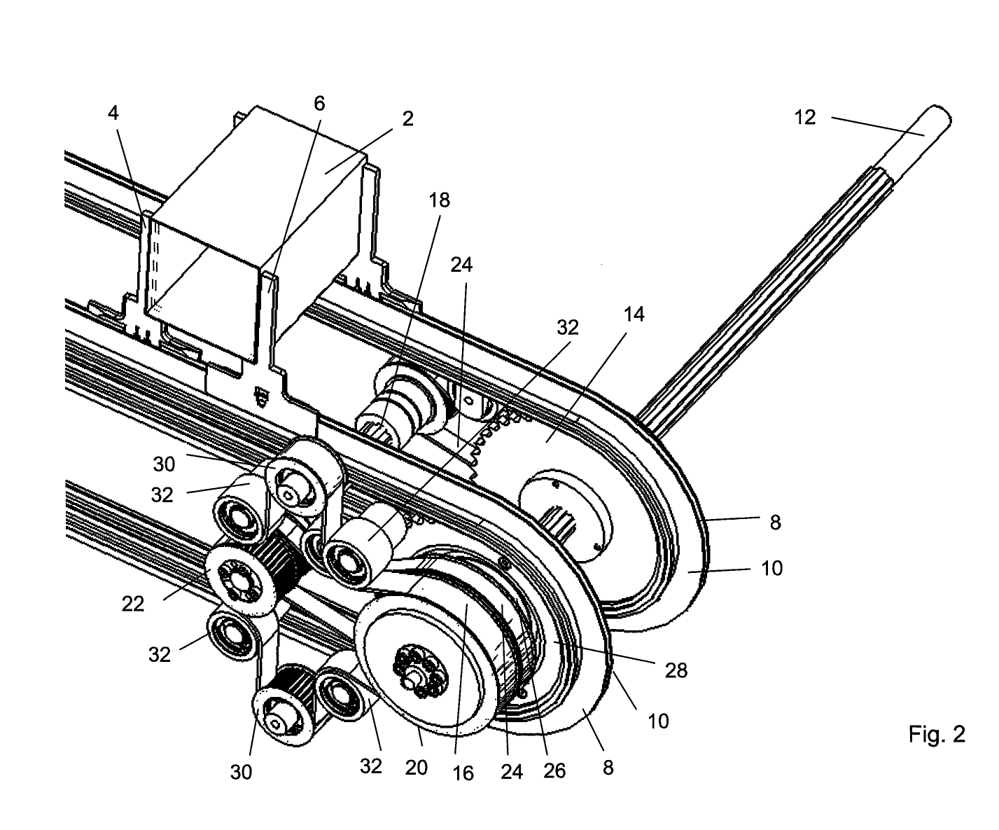

According to the present exemplary embodiment, each receiver cell is formed by first driver elements 4 and second driver elements 6 (see especially FIGS. 1 and 2). In the exemplary embodiment shown here, the first driver elements 4 are designed as pushing driver elements, whereas the second driver elements 6 are designed as counterholding elements. The opposite configuration is also conceivable. The driver elements 4, 6 can be designed as fingers as shown here, but they could also take the form of a continuous plate.

The first driver elements 4 are attached to a first endless transport unit 8, whereas the second driver elements 6 are attached to a second endless transport unit 10, the driver elements projecting from the transport units in each case. The first transport unit 8 and the second transport unit 10 can be designed preferably as roller chains, which, during the operation of the device, are in a fixed relationship to each other. To change the format, this fixed relationship must be suspended, and the transport units 8, 10 must be shifted with respect to each other. As a result, the distance between the first driver elements 4 and the second driver elements 6 is changed, and thus the size of the receiver cell is changed.

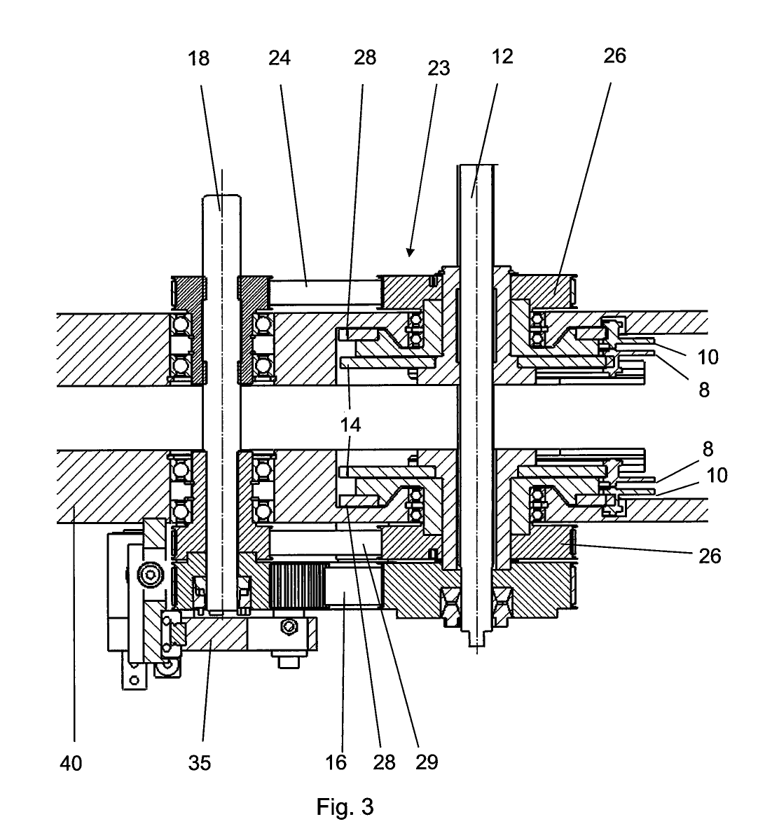

As can be seen especially in FIGS. 2 and 3, a drive shaft 12, which is preferably designed as a spline shaft, drives an engagement unit 14 mounted on it, such as a sprocket, which engages with the first transport unit 8 and drives it. This is preferably done at the reversal point of the endless transport unit 8. The drive shaft 12 itself is driven by a motor (not shown).

From the drive shaft 12, a belt-type or chain-type connecting element 16 leads to an auxiliary shaft 18. As a result, the drive power is transmitted from the drive shaft 12 to the auxiliary shaft 18, which, under normal operating conditions, therefore runs synchronously with the drive shaft 12. The connecting element 16 is designed either as a roller chain or, as shown in the figures, as a toothed belt, and, in a corresponding manner, sprockets or toothed belt pulleys 20, 22, which engage with the connecting element 16, are mounted on the drive shaft 12 and the auxiliary shaft 18.

The auxiliary shaft 18 drives the second transport unit 10. This can be done, for example, by way of a sprocket (not shown) mounted on the auxiliary shaft 18, but preferably the engagement unit 23, which is driven by the auxiliary shaft 18 and engages with the second transport unit 10, is mounted rotatably on the drive shaft 12. This offers the advantage that the points where power is transmitted to the first transport unit 8 and to the second transport unit 10 can be located next to each other and thus in the area where the transport units 8, 10 reverse direction.

In a preferred embodiment, therefore, an additional belt drive 24 extends from the auxiliary shaft 18 to the engagement unit 23, which is supported on the drive shaft 12 and which, in a preferred embodiment, comprises a toothed belt pulley 26 mounted rotatably on the drive shaft 12, this toothed belt pulley being connected to the belt drive 24 and permanently connected to a sprocket 28, which is also supported rotatably on the drive shaft 12, and which in turn engages in the second endless transport unit 10 and thus drives it.

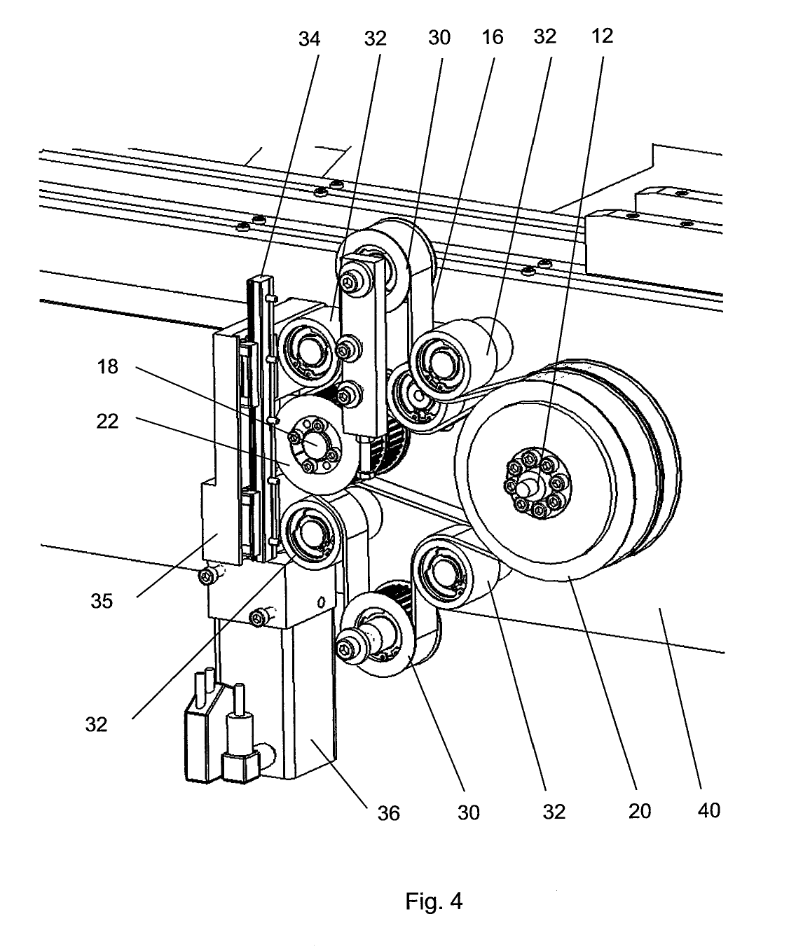

As can be seen most clearly from FIGS. 2 and 4, the connecting element 16 in the example shown here extends between the drive shaft 12 and the auxiliary shaft 18 by way of two adjusting rollers 30 and four auxiliary rollers 32. When the connecting element 16 is designed as a toothed belt, the adjusting rollers 30 will be designed as toothed belt pulleys, whereas the auxiliary rollers 32 can be designed as smooth rollers. When the connecting element 16 is designed as a roller chain, both the adjusting rollers 30 and the auxiliary rollers 32 will be designed as sprockets.

In the exemplary embodiment shown here, one of the two adjusting rollers 30 is arranged above the other, and both can be shifted in the vertical direction. In addition, the two adjusting rollers 30 are of the same size and are shifted over the same distance. Both the auxiliary rollers 32 and the adjusting rollers 30 are axially symmetric to an axis of symmetry, which preferably passes through the axes of rotation of the drive shaft 12 and the auxiliary shaft 18. The connecting element 16 extends as an endless element from the drive shaft 12, around one of the auxiliary rollers 32 (90° turn), around the upper adjusting roller 30 (180° turn), and then around another auxiliary roller 32 (approximately 120° turn). From this point it returns to the drive shaft 12 by first passing around the auxiliary shaft 18 and then by tracing a symmetrical path over two additional auxiliary rollers 32 and the lower adjusting roller 30. Whereas the adjusting rollers 30 are supported so that they can be shifted in a direction perpendicular to their axes of rotation, the auxiliary rollers 32 are preferably supported in a stationary manner, so that, although they can rotate, no translation is possible.

With a design such as this, it is guaranteed that the section of the connecting element 16 which is entering one of the adjusting rollers 30 always stays parallel to the section of the connecting element 16 which is leaving the adjusting roller 30 on the other side (180° turn). As a result, straight, length-compensating sections of the connecting element 16 are created, which, when the two adjusting rollers 30 are shifted in the same direction, become shorter or longer to the same degree. When now the two adjusting rollers 30 are shifted up or down, the adjusting rollers 30 change the angular position of the auxiliary shaft 18 as a result of the change in the position of the connecting element 16. Because the drive power is exerted on the second transport unit 10 by the auxiliary shaft 18, this transport unit also shifts relative to the first transport unit 8. In the example shown here, this is accomplished via the rotation of the toothed belt pulley 26 mounted in freely rotatable fashion on the drive shaft 12 and the rotation of the sprocket 28 permanently connected to it.

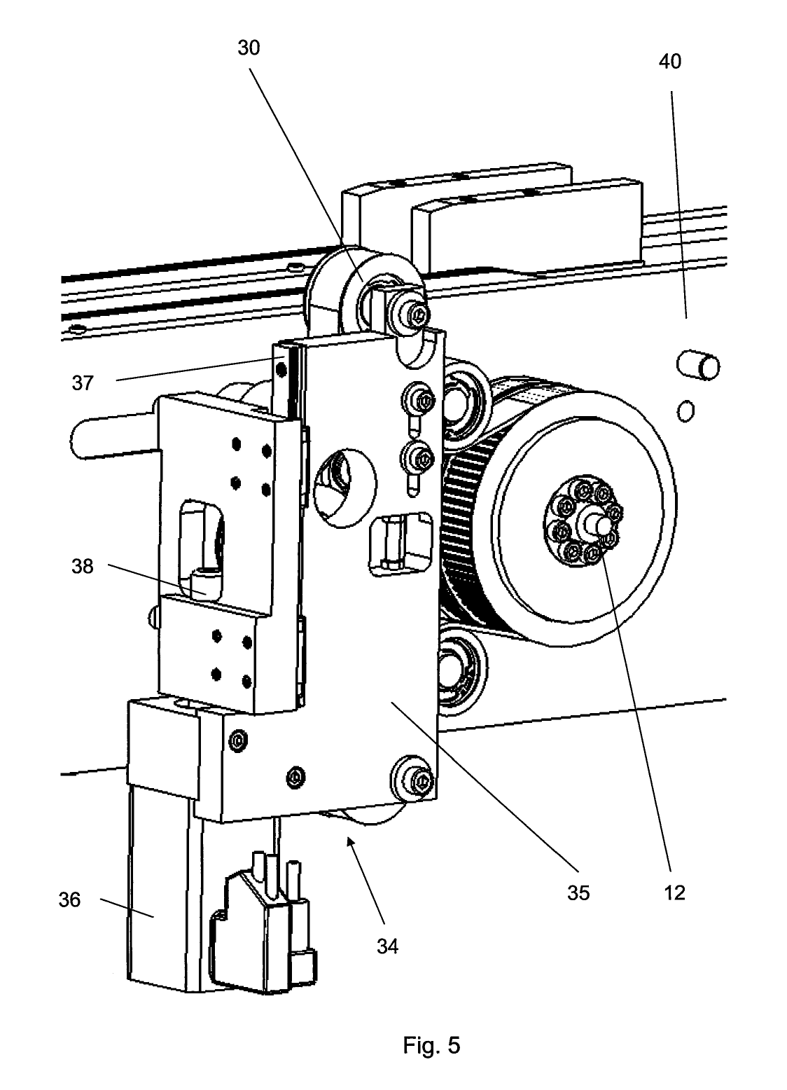

So that the format adjustment can be carried out in fully automated and highly precise fashion, the adjusting rollers 30 can preferably be moved with the help of a linear guide unit 34, which is shown in FIG. 5. In the example shown here, the linear guide unit 34 comprises a format adjusting plate 35, to which the adjusting rollers 30 are attached by screws, for example. The format adjusting plate 35 can be shifted along one or more straight guide rails 37 by means of an adjusting motor 36, for example. The adjusting motor 36 should comprise an integrated absolute encoder. A servomotor can also be used. The adjusting motor 36 can drive a spindle 38, for example, which engages in a thread on the format adjusting plate 35. At the same time, the stationary auxiliary rollers 32 can be mounted on a base plate 40 (see FIG. 4) of the device.

In addition to the embodiment shown here, many other embodiments which fall within the scope of the invention are also possible. For example, more than two adjusting rollers 30 as well as any desired number of auxiliary rollers 32 can be provided. The individual adjusting rollers 30 can be of different sizes, and their position and arrangement can also be varied. The arrangement does not necessarily have to be symmetric or one-above-the other. Shifting the adjusting rollers 30 in the vertical direction is not mandatory either; a horizontal shift of the adjusting rollers 30 is also conceivable, provided that the connecting element 16 is guided suitably. The path along which the adjusting rollers 30 move can also be different in cases where the adjusting rollers 30 are of different sizes or when an odd number of adjusting rollers 30 is provided. The important point in all cases is that the overall distance traveled by the connecting element 16, which is defined by the length of the connecting element 16, remains constant and that, because of the way in which the connecting element 16 is guided, a shift of the adjusting rollers 30 causes the connecting element 16 to move on the auxiliary shaft 18, which in turn produces a change in the angular position of the auxiliary shaft 18.

To ensure a uniform driving action, multiples of some of the elements of the drive section described above are preferably provided and arranged with mirror symmetry with respect to the longitudinal axis of the device. As can be seen especially in FIG. 2, this pertains to the first transport unit 8 with the first driver elements 4, to the second transport unit 10 with the second driver elements 6, to the engagement units 14 and 23, and to the belt drive 24.

Alternatively to the use of the adjusting motor 36 to adjust the adjusting rollers 30, the adjusting rollers 30 could also be adjusted manually, or the spindle 38, which would be equipped with a digital readout, could be rotated by hand.

1. A device for conveying objects in packaging machines, comprising:
a first endless transport unit, which moves first driver elements;
a second endless transport unit, which moves second driver elements;
a drive shaft, which is driven by a motor and which drives the first endless transport unit;
an auxiliary shaft, which drives the second endless transport unit; and
a connecting element for transmitting drive power from the drive shaft to the auxiliary shaft, the connecting element being one of a belt-type and a chain-type;
wherein the connecting element between the drive shaft and the auxiliary shaft is guided over a plurality of stationary auxiliary rollers and over at least two adjusting rollers, which are simultaneously shiftable in a direction perpendicular to axes of rotation of the adjusting rollers, the connecting element being guided in such a way that a shift of the adjusting rollers brings about a movement of the connecting element on the auxiliary shaft and thus a change in an angular position of the auxiliary shaft.

2. The device according to claim 1, wherein the adjusting rollers are shiftable in the same direction.

3. The device according to claim 1, wherein the adjusting rollers are of equal size and are shiftable by the same distance.

4. The device according to claim 1, wherein both the auxiliary rollers and the adjusting rollers are arranged in axially symmetric fashion with respect to an axis of symmetry.

5. The device according to claim 4, wherein the axis of symmetry passes through axes of rotation of the drive shaft and the auxiliary shaft.

6. The device according to claim 1, wherein a section of the connecting element which is entering one of the adjusting rollers extends parallel to a section of the connecting element which is leaving the one of the adjusting roller.

7. The device according to claim 1, wherein the connecting element is a toothed belt, wherein toothed belt pulleys are mounted on the drive shaft and on the auxiliary shaft, and wherein the adjusting rollers are toothed belt pulleys.

8. The device according to claim 1, wherein the connecting element is a roller chain, wherein sprockets are mounted on the drive shaft and on the auxiliary shaft, and wherein the adjusting rollers are sprockets.

9. The device according to claim 1, wherein the adjusting rollers are shiftable by means of a linear guide unit.

10. The device according to claim 9, wherein the linear guide unit comprises a format adjusting plate, which is permanently connected to the adjusting rollers and is guided in at least one straight guide rail.

11. The device according to claim 10, wherein an adjusting motor with an integrated absolute encoder is provided to shift the adjusting rollers.

12. The device according to claim 11, wherein the adjusting motor drives a spindle of the linear guide unit.

13. The device according to claim 1, wherein the auxiliary shaft is connected by a belt drive to an engagement unit supported rotatably on the drive shaft, which engagement unit engages with the second endless transport unit and thus drives it.

14. The device according to claim 13, wherein the engagement unit comprises a toothed belt pulley supported rotatably on the drive shaft, which pulley is connected to the belt drive and is permanently connected to a sprocket, also supported rotatably on the drive shaft, which sprocket in turn engages in the second endless transport unit and thus drives it.
